(19) United States
(12) Patent Application Publication
(10) Pub. No.: US 2009/0249638 A1
(43) Pub. Date: Oct. 8, 2009

(54) APPARATUS AND METHOD FOR REMOVING WATER FROM WET MATERIAL

(76) Inventor: Raymond C. McArthur, Pierre, SD (US)

Correspondence Address: MERCHANT & GOULD PC, P.O. BOX 2903, MINNEAPOLIS, MN, 55402-0903, US

(21) Appl. No.: 12/417,935

(22) Filed: Apr. 3, 2009

Related U.S. Application Data
(60) Provisional application No. 61/042,443, filed on Apr. 4, 2008.

(51) Int. Cl. F26B 5/08

(52) U.S. Cl. 34/328; 34/58

(57) ABSTRACT

An apparatus for separating water from a wet material is provided according to the present invention. The apparatus includes an air lock feeder, a venturi, a plurality of centrifugal accelerators, at least one blower, at least one vapor vent, and at least one product outlet. The air lock feeder is constructed to receive air from a feed blower and move the wet material as entrained material. The venturi is operatively connected to the air lock feeder and is constructed to receive the entrained material and to accelerate the entrained material. The plurality of centrifugal accelerators are operatively connected to the venturi to receive the entrained material and accelerate the flow of the entrained material. The at least one accelerator blower is provided for accelerating the flow of the wet material within the plurality of centrifugal accelerators. The at least one vapor vent is operatively connected to the plurality of centrifugal accelerators for removing water vapor. The at least one product outlet is provided for removing dried material from the plurality of centrifugal accelerators. A method for separating water from a wet material is provided.

This application claims priority to U.S. Provisional Patent Application Ser. No. 61/042,443 that was filed with the United States Patent and Trademark Office on Apr. 4, 2008. The entire disclosure of U.S. Provisional Patent Application Ser. No. 61/042,443 is incorporated herein in its entirety.

### FIELD OF THE INVENTION

The invention relates to an apparatus and a method for removing water from wet material. In particular, the wet material can include waste products, processed materials, and raw materials.

### BACKGROUND

Waste products, processed materials, and raw materials from various sources often include water as a component. The ability to use the wet material is often limited because of the presence of water. The presence of water has a tendency to increase the cost of transporting the wet material. Furthermore, the presence of water in the wet material often results in a transformation of the wet material. For example, the presence of certain amounts of water may cause the material to degrade or transform in some manner. Furthermore, it is often too costly or time consuming to remove water by conventional drying techniques.

There is a need in many industries to economically recover valuable products from what are considered to be waste streams having a high moisture content and a non-uniform particle size. By removing water, valuable products can be recovered. By providing materials having a substantially uniform size and moisture content, the material can be more conveniently used. Furthermore, by reducing the water content to a certain level, the material can be considered stable, and can be used for other applications.

There are several industries that generate waste streams that can be dried to provide a desirable material. Exemplary industries include agriculture, food processing, mining, coal, pulp and paper, and oil and gas industries. As an example, livestock feed lots produce large amounts of raw manure. One technique of disposal is to apply the raw manure to the land. However, such operations have become an environmental concern for a number of reasons, and in view of the large volume of manure produced (e.g. estimated to be about 1.4 billion tons of manure in the U.S.A. alone in 1998), stockpiles of manure and other waste products are becoming a significant cause for concern.

While presently a cause for concern, raw manure, when properly processed, has many applications. It can be used as a fertilizer, a soil amendment for such areas as parks, golf courses, and lawns, and in a number of other situations. In known systems, raw manure is typically mechanically milled or ground with hammer mills or grinders prior to processes in which the manure is dried in a rotary drum drier at between 350-500° F. using an external heat source. A roll compactor is then used to form briquettes from the pulverized and dried raw manure, which are then re-ground to a desired granule size. Such systems have a number of environmental and economic drawbacks.

Not only is conventional processing marginally or not cost effective, it also significantly reduces the quality of the processed product. The heat used for drying not only is produced expensively and with environmentally adverse consequences, but it destroys a significant amount of the organic material in the manure. Also, the forming process produces a greater volume of airborne products that can present a health and safety hazard, requiring the utilization of air pollution controls.

### SUMMARY

An apparatus for separating water from wet material is provided according to the present invention. The apparatus includes an air lock feeder, a venturi, a plurality of centrifugal accelerators, at least one accelerator blower, at least one vapor vent, and at least one product outlet. The air lock feeder is constructed to receive air from a feed blower and move the wet material as entrained material. The venturi is operatively connected to the air lock feeder and is constructed to receive the entrained material and to accelerate the entrained material. The plurality of centrifugal accelerators are operatively connected to the venturi to receive the entrained material and accelerate the flow of the entrained material. The at least one accelerator blower is provided for accelerating the flow of the wet material within the plurality of centrifugal accelerators. The at least one vapor vent is operatively connected to the plurality of centrifugal accelerators for removing water vapor. The at least one product outlet is provided for removing dried material from the plurality of centrifugal accelerators.

A method for separating water from a wet material is provided according to the present invention. The method includes steps of: (a) providing the wet material as entrained material and blowing the entrained material through a venturi, feeding the entrained material from the venturi to a plurality of centrifugal accelerators to accelerate the entrained material and separate water therefrom, blowing air into the plurality of centrifugal accelerators to accelerate the flow of the entrained material, removing water vapor from the plurality of centrifugal accelerators, and removing dried material from the plurality of centrifugal accelerators.

It should be understood that the reference to “dried material” does not mean that the material is completely dried. Instead, it means that the dried material contains less water than the wet material. Typically, the dried material is formed as a result of removing surface water and at least some of the absorbed water from the wet material. As a result of being processed through the apparatus, the wet material forms a vapor stream and a dried material stream. The dried material stream can have a water content that is sufficiently low so that the dried material can have a longer life without experiencing significant degradation, can be shipped or transported to another location at a lower cost as a result of the loss of water therefrom, and can be provided having a uniform size distribution.

### BRIEF DESCRIPTION OF THE DRAWINGS

FIG. 1 is a schematic view of an exemplary apparatus for removing water from a wet material according to the principles of the present invention.

FIG. 2 is a diagrammatic view of an exemplary controls process for controlling the operation of the apparatus shown in FIG. 1.

FIG. 3 is a diagrammatic view of an exemplary mechanical extractor for removing at least a portion of surface water or free water from a wet material.

### DETAILED DESCRIPTION

The present invention provides an apparatus and method for removing water from a wet material. Many types or forms of wet material are available that can be dried in order to better utilize the material. The wet material can be a waste product, a processed material, or a raw material. The wet material can be a material resulting from an agricultural process, an industrial process, or a municipal process. Exemplary materials resulting from agricultural processes include, for example, harvested agricultural materials such as grains, produce, etc, and materials resulting from agricultural processes including, for example, manure, animal parts, plant parts, etc. Exemplary materials resulting from industrial processes include, for example, fermentation product, coal, coal fines, wood waste, pulp, paper mill waste, mine tailings, dredge spoils, etc. Exemplary materials resulting from municipal processes include, for example, sewage, manure, etc. By removing water from the wet material, the resulting dried material can be used for various applications. It should be understood that the characterization of a dried material or a dried product does not mean that the product contains no water or that the product must be considered bone dry. Instead, the characterization of a dried material or product should be understood in the context of a drying operation where at least a portion of the water is removed. Preferably, the dried material can be provided having a water or moisture content that is sufficiently low so that the resulting product can be considered stable or at least exhibit increased stability and, therefore, resist degradation or spoilage for a sufficient length of time so that it can be utilized. For many materials, having a water content of greater than about 20 wt. % can cause the material to undergo an undesirable change as a result of degradation or spoilage. Accordingly, it may be desirable to dry certain materials to provide a water content of less than about 20 wt. %. It is often desirable to dry certain materials to provide a water content of less than about 15 wt. %.

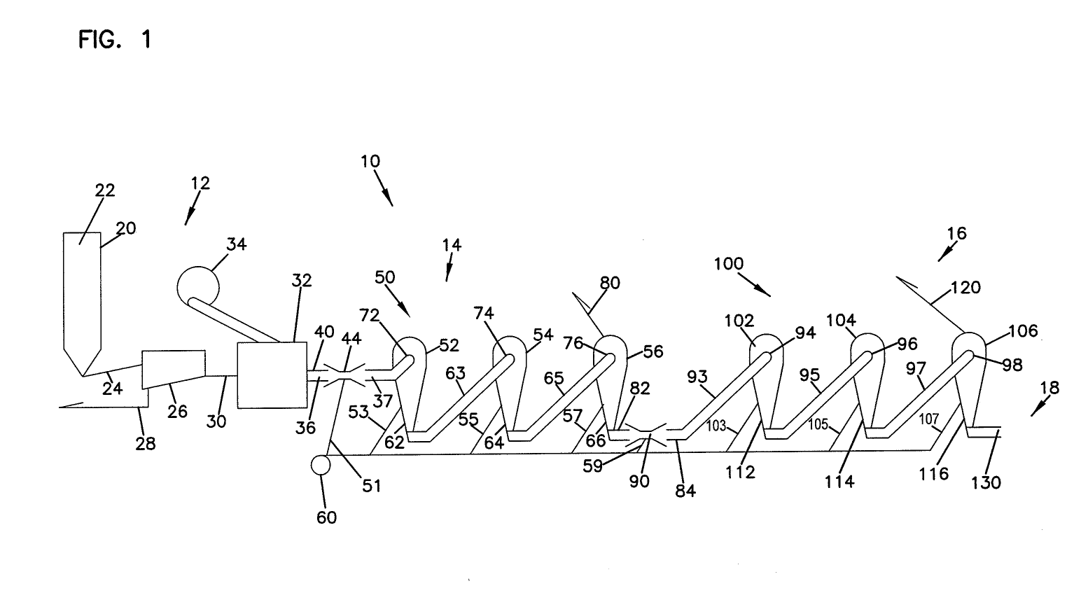

Now referring to FIG. 1, an apparatus for removing water from a wet material is shown at reference number 10. The apparatus 10 can include several general regions where certain types of operations occur. For example, the apparatus 10 includes a wet material extractor and conveyer region 12, a pulverized air dryer region 14, a water recovery region 16, and a dried product region 18.

In general, the wet material conveyer region 12 provides for general mechanical removal of water from the wet material, and conveyance of the wet material to a location where the wet material can become fluidized or entrained in an air stream. In addition, the wet material conveyor region 12 can be provided having a mechanical extractor for the removal of surface moisture from the material. The pulverized air dryer region 14 generally includes the components that act on the entrained material in order to remove water absorbed in the material. The water recovery region 16 refers to the vapor vents that can be provided for separation of water vapor from the entrained material. The dried product region 18 generally refers to the area where dried product is recovered.

Now referring to the wet material conveyer region 12, a wet material container 20 is provided where wet material 22 is contained until fed to a feed belt 24 that conveys the wet material 22 to a mechanical extractor 26. The mechanical extractor 26 operates on the wet material 22 to extract water therefrom. In general, the mechanical extractor 26 operates to remove at least a portion of the surface water from the wet material 22. Water from the mechanical extractor 26 can be recovered via the reclaim water line 28. Exemplary techniques for removing water from the wet material 22 in the mechanical extractor 26 include the use of various presses and rollers and combinations thereof. Exemplary presses include belt presses, cone presses, and impact presses.

The mechanical extractor 26 is provided to remove at least a portion of the surface water or free water from the wet material 22. In general, surface water or free water can be distinguished from absorbed water. Absorbed water generally refers to the water remaining in the material after mechanical extraction. The material resulting from the mechanical extractor 26 can still be referred to as wet material and can be fed via a belt feed 30 to an air lock feeder 32. It should be understood that the wet material conveyer region 12 can be provided with or without the mechanical extractor 26. That is, the wet material 22 may be provided in a form where much of the free water has already been removed therefrom. By way of example, in the case of a fermentation operation, the resulting material (e.g., distilled grain) can have a moisture content in excess of about 60 wt. % and typically greater than about 70 wt. %. The mechanical extractor 26 can reduce the moisture content to less than about 50 wt. % and preferably about 40 wt. % to about 50 wt. %, and the subsequent processing in the pulverized air dryer region 14 can reduce the moisture content down to less than about 30 wt. % and preferably less than about 20 wt. %. Preferably, the resulting dried product can have a moisture content of about 5 wt. % to about 20 wt. %

The air lock feeder 32 is operatively connected with a feed blower 34 that blows air through the air lock feeder 32. The combination of the feed blower 34 and the air lock feeder 32 provides the wet material as entrained material 40 that can be transported as a result of internal flow. The entrained material 40 can flow through the upstream conduit 36, the venturi 44, and the downstream conduit 37. The upstream conduit 36 and the downstream conduit 37 can be characterized as pipes.

The feed blower 34 can provide unheated air or heated air. Unheated air refers to air at about ambient temperature. It should be understood that unheated air can include air that has an elevated temperature as a result of friction or work done on the air. In the case where the feed blower 34 provides heated air, the air can be provided at a temperature of at least about 100° F., and can be provided at a temperature of less than about 130° F. Preferably, the temperature can be provided at about 100° F. to about 125° F. The feed blower 34 can provide the entrained material with a velocity of about at least 10 ft/sec, and preferably about 10 ft/sec to about 20 ft/sec. An exemplary feed blower can be rated to provide a flow of about 6,000 ft³/min at 6 psig and an output temperature of 125° F. Heated air has the advantage of containing more moisture to thereby enhance drying.

Until the water is discharged via the water recovery region 16 or the product is recovered via the dried product region 18, the entrained material 40 can be considered as flowing through internal structures such as conduit (e.g., pipe) or various devices.

The entrained material 40 flows through a venturi 44. The venturi 44 causes the entrained material to flow faster and causes the entrained material to undergo a reduction in pressure. As a result of the increased velocity and the reduction in pressure, it is theorized that the water within the absorbed wet material changes in some manner. For example, the flow through the venturi 44 may cause the water to separate from the product to a certain extent or causes the water to form smaller droplets and thereby increase the surface area of the water. Whatever the precise phenomena that occurs, it is observed that the presence of the venturi 44 assists with the removal of water from the wet material. The venturi 44 can cause the entrained material to at least double its velocity. For example, entrained material flowing through the upstream conduit 36 at about 10 ft/sec to about 20 ft/sec, may experience a velocity increase in the venturi to at least about 30 ft/sec. The velocity in the venturi can be about 30 ft/sec to about 50 ft/sec. Furthermore, the reduction in pressure can be a reduction of at least about 20%. The velocity within the venturi 44 can be increased as a result of introducing air from the accelerator blower 60 via the blower line 51. As a result of introducing air through the blower line 51, the velocity through the venturi can be in excess of 50 ft/sec.

The increase in velocity and the decrease in pressure experienced as the entrained material 40 flows through the venturi 44 can be relatively brief. That is, if air is not delivered to the venturi 44 from the accelerator blower 60, and the pipe diameter of the upstream conduit 36 is about the same as the diameter of the downstream conduit 37, then the entrained material will experience the velocity increase and the pressure drop when traveling through the venturi, but may return to about the original velocity and pressure upon leaving the venturi. Furthermore, the delivery of air from the accelerator blower 60 can cause an increase in velocity of entrained material when flowing through the downstream conduit 37 compared to the velocity when flowing through the upstream conduit 36.

After flowing through the venturi 44, the entrained material 40 is subjected to a plurality of centrifugal accelerators 50. The plurality of centrifugal accelerators 50 shown in FIG. 1 includes a first centrifugal accelerator 52, a second centrifugal accelerator 54, and a third centrifugal accelerator 56 arranged in series. The plurality of centrifugal accelerators 50 are arranged in order of increasing diameter. By providing a series arrangement where the centrifugal accelerators increase in diameter, the entrained material can experience an increase in water separation. In general, the entrained material 40 can experience an increase in velocity within an accelerator as the entrained material moves from the accelerator inlet to the accelerator outlet as a result of a decreasing accelerator diameter. By decreasing the accelerator diameter from the inlet to the outlet, the entrained material accelerates as it moves toward the outlet, and it is believed that this increased acceleration enhances separation of water. By way of example, the first centrifugal accelerator 52 can have a diameter of about 28 inches to about 32 inches, the second centrifugal accelerator 54 can have a diameter of about 36 inches to about 48 inches, and the third centrifugal accelerator can have a diameter of about 60 inches to about 72 inches.

An accelerator blower 60 can be provided to introduce air into the plurality of centrifugal accelerators 50. By introducing air into the plurality of centrifugal accelerators 50, the velocity within each accelerator can be increased. Multiple blowers can be used, if desired. As shown in FIG. 1, a single accelerator blower 60 can be provided to deliver air via the blower lines 53, 55, and 57 to the first centrifugal accelerator 52, the second centrifugal accelerator 54, and the third centrifugal accelerator 56. The accelerator blower 60 can provide unheated or heated air to the plurality of centrifugal accelerators 50. Unheated air refers to air at about ambient temperature. It should be understood that unheated air can include air that has an elevated temperature as a result of friction or work done on the air. The accelerator blower 60 can provide heated air at a temperature of at least about 150° F., and can provide air at a temperature of less than about 200° F. Preferably, the accelerator blower 60 provides air at a temperature of about 150° F. to about 190° F. In general, a temperature in excess of about 200° F. may cause damage to the entrained material 40. The accelerator blower 60 can provide air at a velocity of about 50 ft/sec to about 80 ft/sec. An exemplary accelerator blower can be rated to provide a flow of about 4,000 ft³/min at 8 psig and an output temperature of 185° F. It should be understood that the feed blower 34 and the accelerator blower 60 can include a pre-heater in the air intake duct to help elevate and control the air temperature that leaves the blowers. Heated air has the advantage of containing more moisture to thereby enhance drying.

As shown in FIG. 1, the accelerator blower 60 can deliver air to the plurality of centrifugal accelerators near the product outlets 62, 64, and 66. By introducing air into the plurality of centrifugal accelerators 50 proximate the outlets 62, 64, and 66, the air from the accelerator blower 60 has a tendency to reduce plugging in the outlets 62, 64, and 66. For example, in the case of the first centrifugal accelerator 52, the entrained material 40 enters the first centrifugal accelerator 52 at the material inlet 72. The inlet 72 can be provided as tangential meaning that the entrained material 40 flows radially around the interior diameter of the first centrifugal accelerator near the inlet 72. The entrained material 40 continues to circulate about the diameter of the first centrifugal accelerator 52 as it moves axially toward the product outlet 62. Because of the decreasing diameter, the entrained material 40 flows faster. As a result of the increased velocity, the entrained material 40 has a tendency to impact with itself and with the interior walls of the first centrifugal accelerator 52. The general effect within the first centrifugal accelerator 52 can be characterized as a pulverizing effect. As entrained material enters the first centrifugal accelerator 52, the flow within the first centrifugal accelerator 52 is both radial (e.g., cyclonic) and axial in that the material moves downward through the decreasing diameter of the first centrifugal accelerator 52 toward the product outlet 62. This movement downward through the decreasing diameter causes an acceleration. Product collecting near the outlet 62 may be susceptible to plugging. The flow of air from the accelerator blower 60 agitates the product to reduce the occurrence of plugging within the outlet 62. The entrained material 40 then flows via the conduit 63 to the inlet 74 of the second centrifugal accelerator 54. The inlet 74 can be provided as tangential. The entrained material 40 then flows radially around the interior diameter of the second centrifugal accelerator 54. As the entrained material 40 flows radially around the interior diameter of the second centrifugal accelerator 54, it moves downward toward the product outlet 64. As a result of this downward movement, the entrained material 40 has a tendency to increase its flow rate as a result of the decreasing diameter. The entrained material flows out the outlet 64 and via the conduit 65 to the inlet 76 of the third centrifugal accelerator 56. The inlet 76 can be tangential and the entrained material 40 flows radially about the interior of the third centrifugal accelerator 56. The blower lines 53, 55, and 57 can help accelerate the flow of the entrained material 40.

A vapor vent 80 can be provided to draw water vapor from the third centrifugal accelerator 56. It should be understood that the presence of the vapor vent 80 is optional. Furthermore, the first centrifugal accelerator 52 and the second centrifugal accelerator 54 can be provided with vapor vents, if desired. The resulting entrained material 40 then exits the third centrifugal accelerator 56 at the outlet 66, and, if desired, can be collected as dried product.

The resulting entrained material 40 from the plurality of centrifugal accelerators 50 can be collected as dried material or, as shown in FIG. 1, the entrained material 40 can be further processed. For example, the entrained material can flow through an upstream conduit 82, a second venturi 90, and a downstream conduit 84. If desired, the accelerator blower 60 can introduce air into the upstream conduct 82 via the bower line 59. The second venturi 90 can be provided to at least double the velocity of the entrained material 40. The entrained material 40 can then be collected as dried material or allowed to flow from the second venturi 90 to a second plurality of centrifugal accelerators 100, if desired.

The second venturi 90 can be provided to cause the entrained material 40 to accelerate and to experience a decrease in pressure when flowing through the venturi. It is believed that this acceleration and decrease in pressure causes a level of disassociation between the water in the material, or causes the water to reduce in size and thereby increase in surface area. The blower line 59 can optionally provide airflow to the entrained material flowing through the venturi 90 to increase the speed of the entrained material. It should be understood that providing air to the second venturi 90 is optional.

The second plurality of centrifugal accelerators 100 can be provided as a bank of centrifugal accelerators similar to the plurality of centrifugal accelerators 50. That is, the plurality of centrifugal accelerators 100 can include a first centrifugal accelerator 102, a second centrifugal accelerator 104, and a third centrifugal accelerator 106. The centrifugal accelerators can be provided in order of increasing diameter. For example, the first centrifugal accelerator 102 can have a diameter of about 28 inches to about 32 inches, the second centrifugal accelerator 104 can be provided having a diameter of about 36 inches to about 48 inches, and the third centrifugal accelerator 106 can be providing a diameter of about 60 inches to about 72 inches. It should be understood that the characterization of the diameter of the centrifugal accelerator refers to the maximum diameter of the centrifugal accelerator which is provided near the inlet of the centrifugal accelerator.

The accelerator blower 60 can be provided to deliver air via the blower lines 103, 105, and 107 proximate the product outlets 112, 114, and 116 to help prevent clogging at the product outlets. Furthermore, the entrained material 40 can flow into each accelerator via the conduits 93, 95, and 97. The conduits 93, 95, and 97 introduce the entrained material at the accelerator inlets 94, 96, and 98.

Water vapor can be taken off of the centrifugal accelerator 106 via the water vapor vent 120. Furthermore, dry product can be recovered from the centrifugal accelerator 106 via the dry product conduit 130. The resulting dried product can be provided having a moisture content of less than about 30 wt. %, less than about 25 wt. %, less than about 20 wt. %, or less than about 15 wt. %.

An advantage of the apparatus and process is that it can provide a desired level of drying of a material without the use of a conventional dryer.

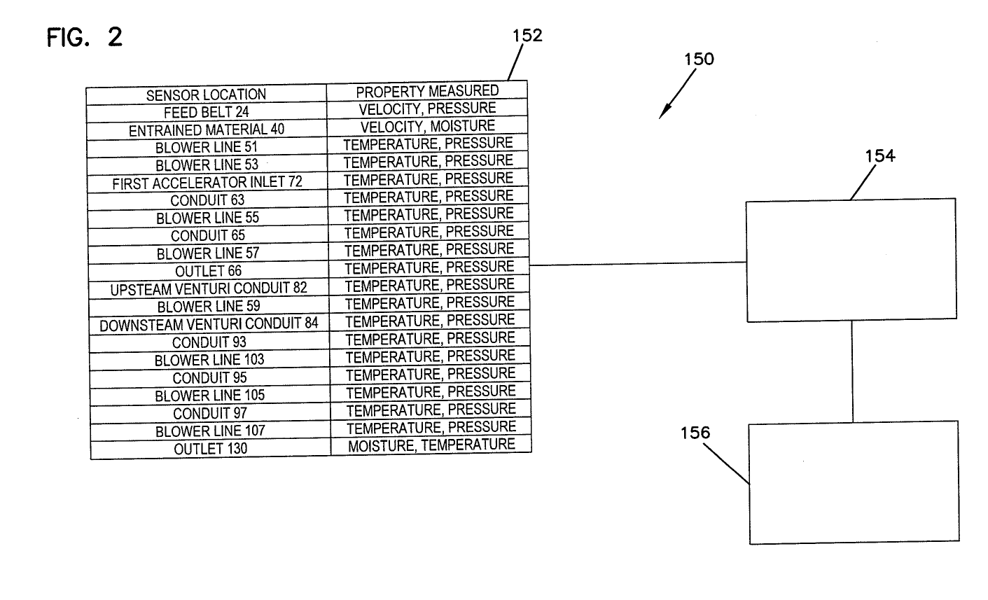

Now referring to FIG. 2, an exemplary controls process is shown schematically at reference number 150. In general, various sensors can be provided at any one or more of the locations 152 identified. The sensor can detect temperature (T), pressure (P), moisture content (M), and velocity (V) and, based on the sensed property, the system control can be manipulated by, for example, a computer control system 154. The computer control system 154 can control various inputs 156 including, for example, the feed blower 34, the accelerator blower 60, and the feed belts 24 and 30. For example, the air velocity and the air temperature at the feed blower 34 and the accelerator blower 60 can be controlled. In addition, the feed rate at the belt feed 24 and at the belt feed 30 can be controlled. As a result of controlling the various inputs 156, the apparatus 10 can be controlled to provide the desired amount of dried material having the desired water content.

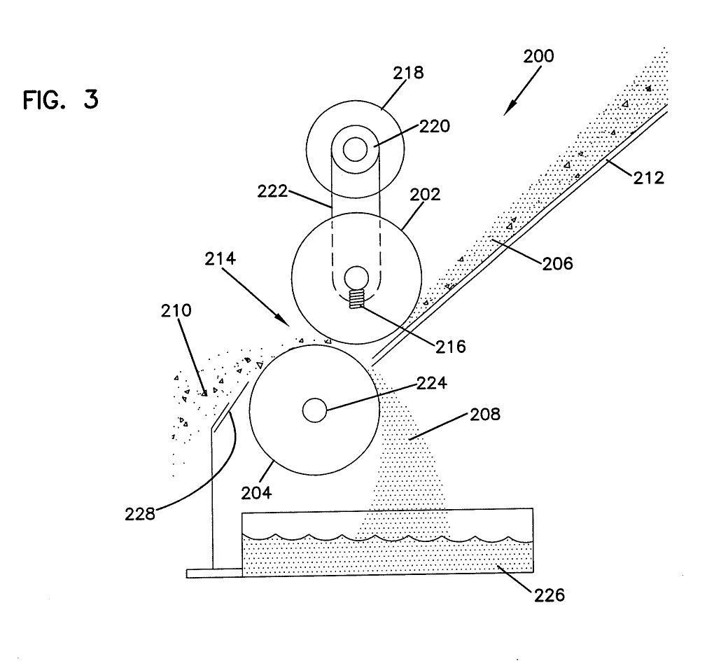

Now referring to FIG. 3, an exemplary mechanical extractor is shown at reference number 200. The mechanical extractor 200 includes a first roller 202 and a second roller 204. As wet material 206 flows between the first roller 202 and the second roller 204, the first roller 202 and the second roller 204 apply pressure to the wet material 206 to thereby squeeze moisture 208 out of the wet material 206. The resulting mechanically extracted material 210 can then be processed by a pulverized air dryer region according to, for example, FIG. 1.

The mechanical extractor 200 includes a ramp 212 that provides for a feed of the wet material 206 to a nip region 214 provided between the first roller 202 and the second roller 204. Pressure can be maintained on wet material 206 between the first roller 202 and the second roller 204 as a result of a spring 216. A motor 218, a drive wheel 220, and belt 222 can cause the first roller 202 to rotate. The second roller 204 can be provided on an idle 224. As the wet material 206 is processed in the nip region 214, the pressure between the first roller 202 and the second roller 204 squeezes out moisture 208 that flows between the second roller 204 and the ramp 212 and into a collection basin 226. The resulting mechanically extracted material 210 can be peeled away from the second roller 204 by a wipe 228. The resulting mechanically extracted material 210 can then be processed for further drying.

Although an exemplary mechanical extractor is shown at reference number 200, alternative mechanical extractors can be utilized for the removal and recovery of surface water.

The above specification provides a complete description of the apparatus and method of the invention. Since many embodiments of the invention can be made without departing from the spirit and scope of the invention, the invention resides in the claims hereinafter appended.

We claim:

1. An apparatus for separating water from wet material comprising:
(a) an air lock feeder constructed to receive air from a feed blower and move the wet material as entrained material;
(b) a venturi operatively connected to the air lock feeder and conduit to receive the entrained material and to accelerate the entrained material;
(c) a plurality of centrifugal accelerators operatively connected to the venturi to receive the entrained material and accelerate the flow of the entrained material;
(d) at least one accelerator blower for accelerating the flow of the wet material within the plurality of centrifugal accelerators;
(e) at least one vapor vent operatively connected to the plurality of centrifugal accelerators for removing water vapor; and
(f) at least one product outlet for removing dried material from the plurality of centrifugal accelerators.

2. An apparatus according to claim 1, further comprising a feed blower constructed to provide the entrained material with a velocity of at least about 10 ft/sec through the conduit.

3. An apparatus according to claim 2, wherein the feed blower provides air at a temperature of about 100° F. to about 125° F.

4. An apparatus according to claim 1, wherein the venturi accelerates the entrained material to a velocity of at least about 30 ft/sec.

5. An apparatus according to claim 1, wherein the venturi is constructed to cause the entrained material to experience a decrease in pressure when flowing therethrough.

6. An apparatus according to claim 5, wherein the venturi causes the entrained material to experience a decrease in pressure by at least about 20% when flowing at a velocity of about 30 ft/sec to about 50 ft/sec.

7. An apparatus according to claim 1, wherein the plurality of centrifugal accelerators comprises a plurality of centrifugal accelerators arranged in series.

8. An apparatus according to claim 7, wherein the plurality of centrifugal accelerators are arranged in order of increasing diameter.

9. An apparatus according to claim 8, wherein the plurality of centrifugal accelerators comprises a first centrifugal accelerator, a second centrifugal accelerator, and a third centrifugal accelerator.

10. An apparatus according to claim 9, wherein the first centrifugal accelerator has a diameter of about 28 inches to about 32 inches.

11. An apparatus according to claim 9, wherein the second centrifugal accelerator has a diameter of about 36 inches to about 48 inches.

12. An apparatus according to claim 9, wherein the third centrifugal accelerator has a diameter of about 60 inches to about 72 inches.

13. An apparatus according to claim 9, wherein the vapor vent is constructed to draw water vapor from the third centrifugal accelerator.

14. An apparatus according to claim 9, wherein the product outlet is constructed to remove product from the third centrifugal accelerator.

15. An apparatus according to claim 9, wherein the accelerator blower feeds air to each of the centrifugal accelerators.

16. An apparatus according to claim 9, wherein the accelerator blower blows air at a temperature of about 150° F. to about 200° F.

17. An apparatus according to claim 1, further comprising a second venturi constructed to receive entrained material from the plurality of centrifugal accelerators.

18. An apparatus according to claim 17, further comprising a second plurality of centrifugal accelerators constructed to receive entrained material from the second venturi.

20. A method for separating water from a wet material, the method comprising:
(a) providing the wet material as entrained material and blowing entrained material through a venturi;
(b) feeding the entrained material from the venturi to a plurality of centrifugal accelerators to accelerate the entrained material and separate water therefrom;
(c) blowing air into the plurality of centrifugal accelerators to accelerate the flow of the entrained material;
(d) removing water vapor from the plurality of centrifugal accelerators; and
(e) removing dried material from the plurality of centrifugal accelerators.

21. A method according to claim 20, further comprising:
(a) feeding the entrained material from the plurality of centrifugal accelerators through a second venturi.

22. A method according to claim 21, further comprising:
(a) feeding the entrained material from the second venturi to a second plurality of centrifugal accelerators.

23. A method according to claim 20, wherein the step of blowing comprises blowing the entrained material at a velocity of at least about 10 ft/sec.

24. A method according to claim 23, wherein the entrained material accelerates to a velocity of at least about 30 ft/sec in the venturi.

25. A method according to claim 24, wherein the entrained material experiences a decrease in pressure of at least about 20% when traveling through the venturi.
